(19) United States
(12) Patent Application Publication
(10) Pub. No.: US 2024/0381176 A1
(43) Pub. Date: Nov. 14, 2024

(54) Crowdsourcing WLAN Mobile Devices as Wi-Fi8 Backscatter Relay

(71) Applicant: Cisco Technology, Inc., San Jose, CA (US)

(72) Inventors: Robert E. Barton, Richmond (CA); Jerome Henry, Pittsboro, NC (US); Indermeet S. Gandhi, San Jose, CA (US)

(73) Assignee: Cisco Technology, Inc., San Jose, CA (US)

(21) Appl. No.: 18/507,912

(22) Filed: Nov. 13, 2023

Related U.S. Application Data
(60) Provisional application No. 63/502,082, filed on May 13, 2023.

(51) Int. Cl. H04W 28/06

(52) U.S. Cl. CPC H04W 28/065; H04W 84/12; H04W 88/04

(57) ABSTRACT

Crowdsourcing client devices as backscatter relays may be provided. A first computing device may determine that a communication is coming from a backscatter communication device. Then the communication may be repackaged into a repackaged communication. The repackaged communication may then be sent to a second computing device.

### RELATED APPLICATION

Under provisions of 35 U.S.C. § 119(e), Applicant claims the benefit of U.S. Provisional Application No. 63/502,082 filed May 13, 2023, which is incorporated herein by reference.

### TECHNICAL FIELD

The present disclosure relates generally to providing crowdsourcing client devices as backscatter relays.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for providing crowdsourcing client devices as backscatter relays;

FIG. 2 is a flow chart of a method for providing crowdsourcing client devices as backscatter relays;

FIGS. 3A, 3B, and 3C illustrate a wireless frame; and

FIG. 4 is a block diagram of a computing device.

### DETAILED DESCRIPTION

### Overview

Crowdsourcing client devices as backscatter relays may be provided. A first computing device may determine that a communication is coming from a backscatter communication device. Then the communication may be repackaged into a repackaged communication. The repackaged communication may then be sent to a second computing device.

Both the foregoing overview and the following example embodiments are examples and explanatory only, and should not be considered to restrict the disclosure's scope, as described and claimed. Furthermore, features and/or variations may be provided in addition to those described. For example, embodiments of the disclosure may be directed to various feature combinations and sub-combinations described in the example embodiments.

### EXAMPLE EMBODIMENTS

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Backscatter Communication (i.e., BackCom) may use, light, ambient, or Radio Frequency (RF) energy to allow battery-less/very low-powered devices to communicate (e.g., at slow speed). These devices may be referred to as Ambient Power (AMP) devices. For example, backscatter communication may be used for passive Radio Frequency Identification (RFID) tags. Internet-of-Things (IoT) sensors may be more and more ubiquitous, and they may be required to have battery power. This battery power requirement may increase maintenance costs. With backscatter communication, a sensor may be battery-less or use a very small battery that may last years harvesting RF energy.

One option for backscatter communication energy harvesting may be ambient RF harvesting. For IoT devices, charging times may depend on how close RF sources are for energy harvesting. An example charging may be 0.4 βW to 60 βW if the transmitting RF is within 15 meters and is transmitting at 30 dBm with 6 dBi antenna. A fully charged capacitor of 24 μF, for example, may drive a backscatter communication IoT device for 3.6 seconds (e.g., 1.5 V and 10 μA may be assumed). A solid-state battery of 1 μAh at 1.5V may drive the backscatter communication IoT devices for 6 minutes (1.5V and 10 μA may be assumed).

Consistent with embodiments of the disclosure, a network (e.g., an Institute Electrical and Electronics Engineers (IEEE) 802.11 wireless Local Area Network (LAN)) may be deployed that may contain several AMP Backscatter Devices (BKDs). The network may be deployed in such a way that the BKDs may be part of and managed by the IEEE 802.11 network, allowing them to communicate with both infrastructure nodes (e.g., Access Point (APs)) as well as client devices (e.g., Stations (STAs)). The BKDs may have been onboarded and may be known by the network controller.

The APs or network controller may be deployed in such a way that they may receive data from BKDs. However, due to the limited range of BKDs, it may be unlikely that all (or even most) BKDs will be within range of an AP such that their transmission may be relayed to the controller.

Consistent with embodiments of the disclosure, the Wireless LAN controller and APs may use all associated client devices on the WLAN as “AMP Relay Agents” (ARAs) to relay BKD communication back to an AP, and on to the controller. No specific client device may be assigned as an AMP relay agent rather, any and all client devices associated to a Basic Service Set (BSS) may be leveraged to perform the role of the AMP relay agent. A client device may opt out of this role, or be deselected from the relay task by an administrator, but the intent may be that most mobile devices on the WLAN may assist as ARAs. This scenario may be likely to be common in industrial environments, where all Wi-Fi assets may be controlled. In additional embodiment, dedicated wireless sensors may be deployed in the WLAN and may be configured to act as ARA.

With embodiments of the disclosure, any mobile Wi-Fi device may be near, or may be passing by a BKD. If the client device hears the BKD transmission, it may be recognized by the client device as coming from a BKD (e.g., on a 2.4 GHz channel). After the BKD transmission has been recognized, the client derive may decode the signal and repackages it into, for example, an IEEE 802.11 frame, which may then be sent to the AP, and then forwarded to the controller.

Accordingly, embodiments of the disclosure may provide a process where any and all client devices on the WLAN may be crowdsourced to act as relay devices for BKD transmissions. Embodiments of the disclosure may also disclose how the frames may be relayed by the client devices to the AP, as well as processes for how duplication of the backscatter transmission may be managed, including an inverted trickle mechanism.

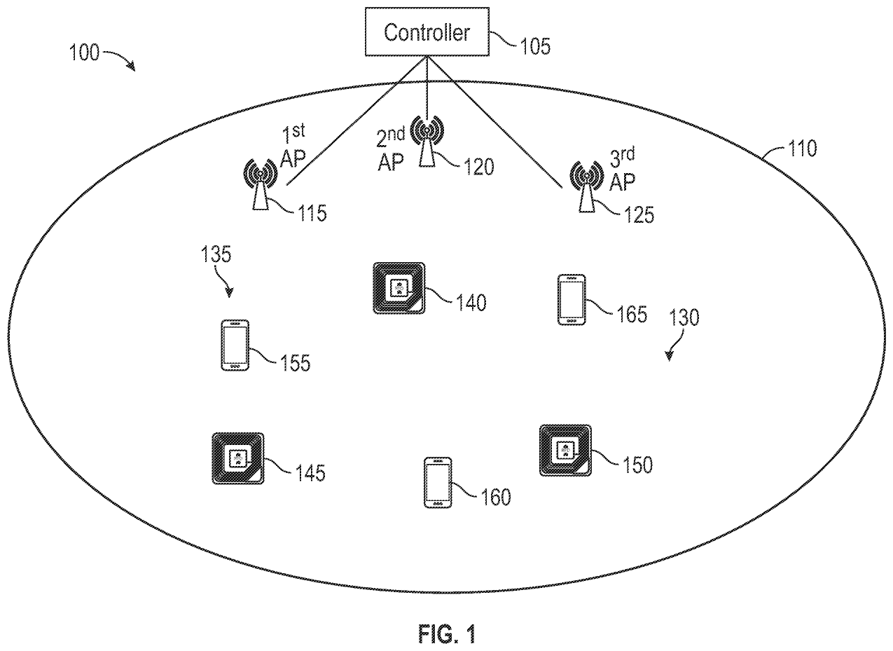

FIG. 1 shows an operating environment 100 for providing crowdsourcing client devices as backscatter relays. As shown in FIG. 1, operating environment 100 may comprise a controller 105 and a coverage environment 110. Coverage environment 110 may comprise, but is not limited to, a Wireless Local Area Network (WLAN) comprising a plurality of Access Points (APs) that may provide wireless network access (e.g., access to the WLAN) for devices. The plurality of APs may comprise a first AP 115, a second AP 120, and a third AP 125. Each of the plurality of APs may be compatible with specification standards such as, but not limited to, the IEEE 802.11 specification standard for example.

A first plurality of devices 130 and a second plurality of devices 135 may be deployed in coverage environment 110. The plurality of APs may provide wireless network access to first plurality of devices 130 and second plurality of devices 135 as the devices move within coverage environment 110. Coverage environment 110 may comprise an outdoor or indoor wireless environment for Wi-Fi or any type of wireless protocol or standard.

First plurality of devices 130 may comprise a first device 140, a second device 145, and a third device 150. First plurality of devices 130 may comprise backscatter communication devices, for example, RFID tags. First plurality of devices 130 may comprise, but are not limited to, general energy harvesting devices (e.g., passive backscatter communication devices) and pure backscatter communication devices. General energy harvesting devices may comprise devices that work in two phases: i) first harvesting RF energy for a time period; then ii) transmitting using this harvested RF energy. General energy harvesting devices may comprise battery-less Bluetooth Low Energy (BLE) chips for example. With a pure backscatter communication device, the RF signal that provides power may also be the one that is backscattered/modified according to some modulation hence encoding some symbols of information. In addition, first plurality of devices 130 may comprise devices that may receive or harvest energy from light energy and then use the energy from light to power transmission. First plurality of devices 130 may also comprise devices that may harvest RF energy to recharge a battery or other energy storage element within the device.

Second plurality of devices 135 may comprise a first client device 155, a second client device 160, and a third client device 165. Ones of second plurality of devices 135 may comprise, but are not limited to, a smart phone, a personal computer, a tablet device, a mobile device, a telephone, a remote control device, a set-top box, a digital video recorder, an Internet-of-Things (IoT) device, a network computer, a router, an AR/VR device an Automated Transfer Vehicle (ATV), a drone, an Unmanned Aerial Vehicle (UAV), a smart wireless light bulb, or other similar microcomputer-based device.

Controller 105 may comprise a Wireless Local Area Network controller (WLC) and may provision and control coverage environment 110 (e.g., a WLAN). Controller 105 may allow the plurality of client devices to join coverage environment 110. In some embodiments of the disclosure, controller 105 may be implemented by a Digital Network Architecture Center (DNAC) controller (i.e., a Software-Defined Network (SDN) controller) that may configure information for coverage environment 110 in order to provide crowdsourcing client devices as backscatter relays.

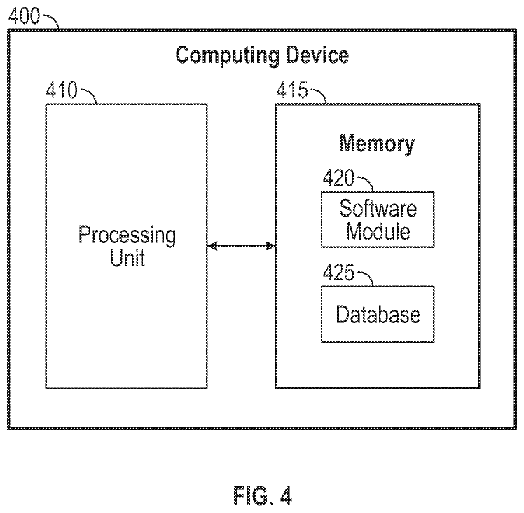

The elements described above of operating environment 100 (e.g., controller 105, first AP 115, second AP 120, third AP 125, first device 140, second device 145, third device 150, first client device 155, second client device 160, and third client device 165) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 4, the elements of operating environment 100 may be practiced in a computing device 400.

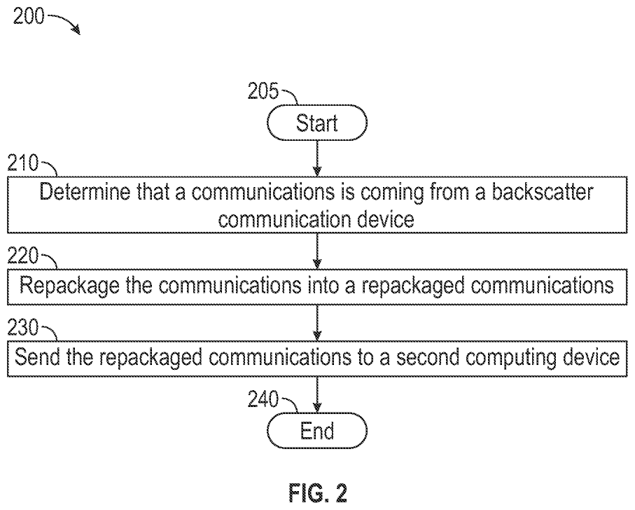

FIG. 2 is a flow chart setting forth the general stages involved in a method 200 consistent with embodiments of the disclosure for providing crowdsourcing client devices as backscatter relays. Method 200 may be implemented using first client device 155, which may be embodied by a computing device 400 as described in more detail below with respect to FIG. 4. Ways to implement the stages of method 200 will be described in greater detail below.

Method 200 may begin at starting block 205 and proceed to stage 210 where computing device 400 (e.g., first client device 155) may determine that a communication is coming from a backscatter communication device (e.g., first device 140). For example, for client devices to act as ARAs, they first may recognize that a transmission is coming from a BKD. In some embodiments, to support this capability, embodiments of the disclosure may provide a backscatter communication device (e.g., first device 140) a longer preamble for environments with passive BKDs. In IEEE 802.11 communication, the preamble may comprise a waveform received above a certain Received Signal Strength Indicator (RSSI) level that informs a device that radio communication is of the IEEE 802.11 format, requiring that it process the signal as such. In Wi-Fi deployments (e.g., operating environment 100), all client devices (e.g., second plurality of devices 135) may continually search for a compatible preamble waveform when they are not either receiving, transmitting, or sleeping for example.

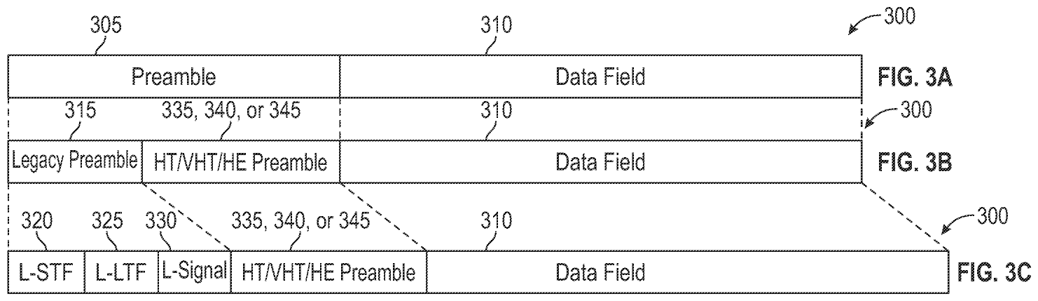

FIGS. 3A, 3B, and 3C illustrate a wireless frame 300. Wireless frame 300 may comprise a preamble 305 and a data field 310. The preamble may also be called the Physical header and it is prepended to the data field that carries the frame body. As shown in FIG. 3C, preamble 305 may further be divided into smaller parts. The first part may comprise a legacy preamble 315 comprising a Legacy-Short Training Field (L-STF) 320, a Legacy-Long Training field (L-LTF) 325, and a Legacy-Signal field (L-SIG) 330. If wireless frame 300 is sent with Modulation Coding Scheme (MCS) data rates, preamble 305 may also include a High Throughput (HT) preamble 335, a Very High Throughput (VHT) preamble 340, or a High Efficiency (HE) preamble 345 right after legacy preamble 315, but before data field 310. Some frame formats may comprise only legacy preamble 315 and data field 310.

As a passive BKD (e.g., first device 140) starts backscattering as soon as energy is detected, the BKD transmission may be completed by the end of the header (e.g., preamble 305). If energy is still present in the medium, the passive BKD (e.g., first device 140) may continue being activated and may repeat the same transmission many times. Accordingly, with embodiments of the disclosure, the end of L-STF 320, L-LTF 325, L-SIG 330, HT preamble 335, VHT preamble 340, or HE preamble 345, may be followed by another preamble (e.g., a backscatter preamble) of a simple structure (e.g., modeled on the L-LTF). The backscatter preamble that may allow second plurality of devices 135 to use the first preamble (e.g., preamble 305) to acquire the signal, and the second preamble (e.g., the backscatter preamble) to read the entire passive BKD signal.

An administrator may have the ability to turn on/off the backscatter preamble and its detection in the network if necessary. When turned off, no client device may participate as an ARA. When turned on, all client devices (apart from those granted an exception) may become ARAs.

From stage 210, where computing device 400 (e.g., first client device 155) determines that the communication is coming from the backscatter communication device (e.g., first device 140), method 200 may advance to stage 220 where computing device 400 may repackage the communication into a repackaged communication. For example, after a BKD transmission from first device 140 has been recognized by first client device 155, first client device 155 may decode the signal and repackages it into, for example, an IEEE 802.11 frame, which may then be sent to the AP, and then forwarded to the controller.

Once computing device 400 (e.g., first client device 155) repackages the communication into the repackaged communication in stage 220, method 200 may continue to stage 230 where computing device 400 may send the repackaged communication to a second computing device (e.g., first AP 115). For example, after first client device 155 decodes the signal and repackages it into, for example, an IEEE 802.11 frame, first client device 155 may then send the repackaged communication to first AP 115. First AP then forwarded to controller 105. Once computing device 400 sends the repackaged communication to the second computing device (e.g., first AP 115) in stage 230, method 200 may then end at stage 240.

### Processes to Manage Duplication

With embodiments of the disclosure, if multiple nearby client devices hear the BKD transmission, they all may perform the same function: i) recognize the preamble pattern; ii) decode the raw BKD transmission; and iii) send the BKD data payload to the controller. For the ARAs supporting multi-radio, they could listen for BKD transmission (e.g., specific preamble) on one radio and use the other radio to transmit to an AP or a controller. This may result in multiple copies of the same message being sent to the AP or controller. Accordingly, the AP and the controller may both momentarily buffer the incoming message. After recognizing that it has come as a relayed transmission from a client device, any received duplicate messages may be discarded, while the first received message may be processed.

If there are a large number of client devices nearby all relaying the same BKD transmission, this may be highly inefficient, as many client devices may be repeating the same message that the infrastructure may only need once. Accordingly, in another embodiment, an inverted trickle mechanism may be used to select which client devices may transmit the BKD transmission back to the wireless infrastructure. In this embodiment, each client device may start a repeat counter (e.g., how many times the client device has repeated a BKD signal over the last interval).

Next, when the client device detects and acquires a BKD signal, it prepares to repeat it. Thus, the BKD message may be placed in the client device's buffer, and Network Allocation Vector (NAV) rules apply while the client devices selects a countdown timer and prepares to send a frame to the AP that contains the BKD message. As the countdown continues, other client devices may be sending frames in the BSS. In one embodiment, the client device may update its NAV. In another embodiment, the client device may listen to the transmission and identify that another client device is repeating the BKD message.

When the client device countdown timer gets down to 0, and the client device may repeat the BKD message. The message (which may be very short) may be sent to a specific multicast address. The BKD repeat counter may be increased. As another BKD message is detected, the client device prepares to repeat it. As the counter is already set to 1, the countdown timer is picked in a larger range than the first time.

As the client device counts down, other client devices may access the BSS. As the client device recognizes messages sent to the intended multicast address, it may recognize that another client device is repeating the message that it was intending to repeat. If the client device detects more than a configurable number of repeats (e.g., 3) of the target message while it counts down, the client device considers the message as already transmitted and flushes it out of its buffer without transmitting it.

As the process repeats, the BKD repeat counter decays to 0 at the end of a given interval, causing the client device to pick up, for the next repeat, a shorter countdown timer. Thus, with this mechanism, the BKD message is only repeated a small number of times. In high density where multiple client devices may repeat a given BKD message, the inverse trickle process causes the task of repeating messages to be spread among client devices, as a client device that has already repeated one or more messages in a given interval waits longer and longer before repeating more messages. Thus this gives the opportunity to client devices who have not repeated any message in the previous interval to have their countdown timer reach 0 first, repeat the message, and cause the waiting client device to conclude that the message was already repeated enough times. At the scale of the Extended Service Set (ESS), the effect is that all BKD messages are repeated a few times, but no more, and the load of the repartition task is spread among ARAs.

FIG. 4 shows computing device 400. As shown in FIG. 4, computing device 400 may include a processing unit 410 and a memory unit 415. Memory unit 415 may include a software module 420 and a database 425. While executing on processing unit 410, software module 420 may perform, for example, processes for providing crowdsourcing client devices as backscatter relays as described above with respect to FIG. 2. Computing device 400, for example, may provide an operating environment for controller 105, first AP 115, second AP 120, third AP 125, first device 140, second device 145, third device 150, first client device 155, second client device 160, and third client device 165. Controller 105, first AP 115, second AP 120, third AP 125, first device 140, second device 145, third device 150, first client device 155, second client device 160, and third client device 165 may operate in other environments and are not limited to computing device 400.

Computing device 400 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 400 may comprise any computer operating environment, such as hand-held devices, multiprocessor systems, microprocessor-based or programmable sender electronic devices, minicomputers, mainframe computers, and the like. Computing device 400 may also be practiced in distributed computing environments where tasks are performed by remote processing devices. The aforementioned systems and devices are examples and computing device 400 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communication units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 400 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
determining, by a first computing device, that a communication is coming from a backscatter communication device;
repackaging the communication into a repackaged communication; and
sending the repackaged communication to a second computing device.

2. The method of claim 1, wherein determining that the communication is coming from the backscatter communication device comprises determining that the communication comprises a backscatter preamble.

3. The method of claim 2, wherein the backscatter preamble comes after one of a Legacy Short Training field (L-STF), a Legacy-Long Training field (L-LTF), and a Legacy-Signal field (L-SIG) in the communication.

4. The method of claim 2, wherein the backscatter preamble comes after one of a High Throughput (HT) preamble, a Very High Throughput (VHT) preamble, and a High Efficiency (HE) preamble.

5. The method of claim 1, wherein repackaging the communication into the repackaged communication comprises repackaging the communication into an IEEE 802.11 frame.

6. The method of claim 1, wherein the backscatter communication device comprises a passive backscatter communication device.

7. The method of claim 1, wherein sending the repackaged communication to the second computing device comprises using an inverted trickle process to manage duplication.

8. The method of claim 1, wherein the first computing device comprises a client device.

9. The method of claim 1, wherein the second computing device comprises an Access Point.

10. The method of claim 1, wherein comprising forwarding, by second computing device, the repackaged communication to a network controller.

11. A system comprising:
a memory storage; and
a processing unit disposed in a first computing device, the processing unit coupled to the memory storage, wherein the processing unit is operative to:
determine that a communication is coming from a backscatter communication device;
repackage the communication into a repackaged communication; and
send the repackaged communication to a second computing device.

12. The system of claim 11, wherein determining that the communication is coming from the backscatter communication device comprises determining that the communication comprises a backscatter preamble.

13. The system of claim 12, wherein the backscatter preamble comes after one of a Legacy Short Training field (L-STF), a Legacy-Long Training field (L-LTF), and a Legacy-Signal field (L-SIG) in the communication.

14. The system of claim 12, wherein the backscatter preamble comes after one of a High Throughput (HT) preamble, a Very High Throughput (VHT) preamble, and a High Efficiency (HE) preamble.

15. The system of claim 11, wherein the processing unit being operative to send the repackaged communication to the second computing device comprises the processing unit being operative to use an inverted trickle process to manage duplication.

16. A non-transitory computer-readable medium that stores a set of instructions which when executed perform a method executed by the set of instructions comprising:
determining, by a first computing device, that a communication is coming from a backscatter communication device;
repackaging the communication into a repackaged communication; and
sending the repackaged communication to a second computing device.

17. The non-transitory computer-readable medium of claim 16, wherein determining that the communication is coming from the backscatter communication device comprises determining that the communication comprises a backscatter preamble.

18. The non-transitory computer-readable medium of claim 17, wherein the backscatter preamble comes after one of a Legacy Short Training field (L-STF), a Legacy-Long Training field (L-LTF), and a Legacy-Signal field (L-SIG) in the communication.

19. The non-transitory computer-readable medium of claim 17, wherein the backscatter preamble comes after one of a High Throughput (HT) preamble, a Very High Throughput (VHT) preamble, and a High Efficiency (HE) preamble.

20. The non-transitory computer-readable medium of claim 16, wherein sending the repackaged communication to the second computing device comprises using an inverted trickle process to manage duplication.
